(19) United States
(12) Patent Application Publication
(10) Pub. No.: US 2023/0189821 A1
(43) Pub. Date: Jun. 22, 2023

(54) PESTICIDAL COMPOSITIONS WITH ENHANCED PHYSICAL CHARACTERISTICS

(71) Applicant: Terramera, Inc., Vancouver (CA)

(72) Inventors: Hangsheng LI, Vancouver (CA); Doug Ta Hsung CHOU, Vancouver (CA); Annett ROZEK, Port Moody (CA)

(21) Appl. No.: 17/923,361

(22) PCT Filed: May 6, 2021
(86) PCT No.: PCT/CA2021/050637

§ 371 Date: Nov. 4, 2022

Related U.S. Application Data
(60) Provisional application No. 63/021,228, filed on May 7, 2020.

(51) Int. Cl. A01N 65/26; A01N 65/40; A01N 65/20; A01N 25/02; A01P 15/00

(52) U.S. Cl. CPC A01N 65/26; A01N 65/40; A01N 65/20; A01N 25/02; A01P 15/00

(57) ABSTRACT

A pesticidal mixture of an oil and an aliphatic acid is provided. In mixture, the aliphatic acid and oil are each effective to reduce the mixture's melting point (or viscosity transition point) to below the oil's and acid's melting points (or viscosity transition points). The mixture can be eutectic, such that the melting point of the mixture is less than both the oil melting point and the acid melting point. The oil can be a fatty acid ester, such as a wax ester. The aliphatic acid can be a fatty acid. Pesticidal mixtures comprising various natural pesticidal oils are disclosed, including neem oil, palm oil, coconut oil, and karanja oil.

### CROSS-REFERENCE TO RELATED APPLICATIONS

This application claims priority to, and the benefit of, U.S. Provisional Patent Application No. 63/021,228 filed 7 May 2020, the entirety of which is incorporated by reference herein in its entirety.

### TECHNICAL FIELD

The present disclosure relates generally to pesticidal compositions, and particularly to pesticidal compositions with improved physical characteristics such as those related to the transportation and application of the pesticidal composition in, e.g., agricultural, horticultural or household pest control contexts.

### BACKGROUND

Pesticides, including fungicides, herbicides, nematicides and insecticides, are important compositions for use in domestic, agricultural, industrial and commercial settings, such as to provide for control of unwanted pests and/or pathogens. At least some pesticidal compositions comprise ingredients which may solidify or otherwise undergo an undesirable phase and/or viscosity change before and/or during transportation, application, or after application of the pesticidal compositions. Such solidification and/or other phase or viscosity change can inhibit the effective application of the pesticidal composition, for example by inhibiting spraying, fumigation, and/or other dispersal or inhibiting of the pesticidal composition.

It is often laborious to mitigate issues caused by phase and/or viscosity changes in pesticidal compositions. One common approach is to apply heat to the composition to melt solidified ingredients. This can be undesirable for applicators, e.g. because generating heat generally requires energy, equipment, and time, all of which would be preferably applied elsewhere. Other approaches may involve adding (or removing) compounds to (or from) the pesticidal composition to affect its chemical characteristics, such as by adding a solvent, removing certain readily-solidified fractions from ingredients in the pesticidal composition, and/or adding a polymeric pour point depressant to the pesticidal composition (such as is described in, for example, U.S. patent application No. 62/655,335, incorporated herein by reference).

There is a general desire improved pesticidal compositions having enhanced physical characteristics, including improved phase-change and/or viscosity characteristics.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a pesticidal composition comprising an oil having an oil melting point and an aliphatic acid having an acid melting point. The aliphatic acid and oil form a mixture having a mixture melting point below the oil melting point and the acid melting point. At least one of: the aliphatic acid is effective to reduce the mixture melting point to below the oil melting point, and the oil is effective to reduce the melting point of the mixture to below the acid melting point.

In some embodiments, a weight ratio of the oil to the aliphatic acid is between about 90:10 and 10:90. For example, the weight ratio of the oil to the aliphatic acid may be between about at least one of: 90:10 and 20:80; 90:10 and 30:70; 90:10 and 40:60; 90:10 and 50:50; 90:10 and 60:40; 90:10 and 70:30; 90:10 and 80:20; 80:20 and 10:90; 80:20 and 20:80; 80:20 and 30:70; 80:20 and 40:60; 80:20 and 50:50; 80:20 and 60:40; 80:20 and 70:30; 70:30 and 10:90; 70:30 and 20:80; 70:30 and 30:70; 70:30 and 40:60; 70:30 and 50:50; 70:30 and 60:40; 60:40 and 10:90; 60:40 and 20:80; 60:40 and 30:70; 60:40 and 40:60; 60:40 and 50:50; 50:50 and 10:90; 50:50 and 20:80; 50:50 and 30:70; and 50:50 and 40:60.

In some embodiments, the composition comprises a pesticidal active ingredient comprising at least one of the oil and the aliphatic acid.

In some embodiments, the aliphatic acid comprises a saturated or unsaturated fatty acid. In some embodiments, the fatty acid has a carbon chain length no greater than 12. In some embodiments, the fatty acid comprises at least one of: a trans-unsaturated C—C bond, a cis-unsaturated C—C bond, and a plurality of conjugated unsaturated C—C bonds. In some embodiments, the fatty acid comprises at least one of: a trans-2, trans-3, trans-4, trans-5, trans-6, trans-7, trans-8, trans-9, trans-10, trans-11, cis-2, cis-3, cis-4, cis-5, cis-6, cis-7, cis-8, and cis-9, cis-10, and cis-11 unsaturated bond. In some embodiments, the fatty acid comprises at least one of a trans-hexenoic acid, a cis-hexenoic acid, a hexa dienoic acid, a hexynoic acid, a trans heptenoic acid, a cis heptenoic acid, a hepta dienoic acid, a heptynoic acid, a trans octenoic acid, a cis octenoic acid, an octa dienoic acid, an octynoic acid, a trans nonenoic acid, a cis nonenoic acid, a nona dienoic acid, a nonynoic acid, a trans decenoic acid, a cis decenoic acid, a deca dienoic acid, a decynoic acid, a trans dodecenoic acid, a cis dodecenoic acid, a dodeca dienoic acid, a dodecynoic acid, hexanoic acid, heptanoic acid, octanoic acid, nonanoic acid, decanoic acid, and dodecanoic acid. In some embodiments, the fatty acid is selected from the group consisting of: trans-3 hexenoic acid, octanoic acid, decanoic acid, and oleic acid.

In some embodiments, the oil comprises a fatty acid ester. In some embodiments, the fatty acid ester comprises a wax ester. In some embodiments, the wax ester comprises an extract, constituent, and/or derivative of a natural pesticidal oil selected from the group consisting of: neem oil, karanja oil, clove oil, clove leaf oil, peppermint oil, spearmint oil, mint oil, cinnamon oil, thyme oil, oregano oil, rosemary oil, geranium oil, lime oil, lavender oil, anise oil, lemongrass oil, tea tree oil, apricot kernel oil, bergamot oil, carrot seed oil, cedar leaf oil, citronella oil, clove bud oil, coriander oil, coconut oil, eucalyptus oil, evening primrose oil, fennel oil, ginger oil, grapefruit oil, nootkatone(+), grapeseed oil, lavender oil, marjoram oil, pine oil, scotch pine oil, garlic oil, and/or safflower oil, and combinations thereof.

In some embodiments, the mixture melting point is between about −5° C. and at least one of: 0° C., 5° C., 10° C., 15° C., 20° C., 25° C., and 30° C.

In some embodiments, the oil comprises at least one of palm oil, coconut oil, and karanja oil; the aliphatic acid comprises octanoic acid, and the weight ratio of the oil to the octanoic acid is between about at least one of: 90:10 and 60:40, 90:10 and 70:30, 90:10 and 80:20, 80:20 and 60:40, 80:20 and 70:30, 70:30 and 60:40, 85:15 and 75:25, and 65:35 and 55:45.

In some embodiments, the oil comprises neem oil; the aliphatic acid comprises oleic acid, and the weight ratio of the neem oil to the oleic acid is between about at least one of: 80:20 and 40:60, 80:20 and 50:50, 80:20 and 60:40, 80:20 and 70:30, 70:30 and 40:60, 70:30 and 50:50, 70:30 and 60:40, 60:40 and 40:60, 60:40 and 50:50, and 50:50 and 40:60.

In some embodiments, the oil comprises neem oil; the aliphatic acid comprises trans 3 hexenoic acid, and the weight ratio of the neem oil to the trans 3 hexenoic acid is between about at least one of: 90:10 and 40:60, 90:10 and 50:50, 90:10 and 60:40, 90:10 and 70:30, 90:10 and 80:20, 80:20 and 40:60, 80:20 and 50:50, 80:20 and 60:40, 80:20 and 70:30, 70:30 and 40:60, 70:30 and 50:50, 70:30 and 60:40, 60:40 and 40:60, 60:40 and 50:50, and 50:50 and 40:60.

In some embodiments, the oil comprises neem oil; the aliphatic acid comprises decanoic acid, and the weight ratio of the neem oil to the decanoic acid is between about at least one of: 90:10 and 80:20, and 85:15 and 75:25.

In some embodiments, the oil comprises neem oil; the aliphatic acid comprises octanoic acid, and the weight ratio of the neem oil to the octanoic acid is between about at least one of: 80:20 and 60:40, 80:20 and 70:30, 70:30 and 60:40, and 75:25 and 65:35.

In some embodiments, the mixture comprises a eutectic mixture of the aliphatic acid and the oil having a eutectic point below the oil melting point and the acid melting point, the aliphatic acid is effective to reduce the mixture melting point to below the oil melting point, and the oil is effective to reduce the melting point of the mixture to below the acid melting point.

Some aspects of the present disclosure provide a method for making a pesticidal composition comprising mixing an oil having an oil melting point with an aliphatic acid having an acid melting point. thereby forming a mixture having a mixture melting point below the oil melting point and the acid melting point. At least one of: the aliphatic acid is effective to reduce the mixture melting point to below the oil melting point, and the oil is effective to reduce the melting point of the mixture to below the acid melting point.

Some aspects of the present disclosure provide a method for enhancing a pesticidal composition comprising an oil. The method comprises mixing an aliphatic acid with the oil. The aliphatic acid is effective to reduce a melting point of at least the oil in the pesticidal composition. Some aspects of the present disclosure provide a method for enhancing a pesticidal composition comprising an aliphatic acid. The method comprises mixing an oil with the aliphatic acid. The oil is effective to reduce a melting point of at least the aliphatic acid in the pesticidal composition.

Some aspects of the present disclosure provide a method for enhancing the properties of a pesticidal composition. The method comprises providing an oil having an oil melting point; selecting an aliphatic acid effective to reduce a melting point of the oil when the aliphatic acid and oil are in mixture; and mixing the aliphatic acid and oil.

Some aspects of the present disclosure provide a method for enhancing the properties of a pesticidal composition. The method comprises providing an aliphatic acid having an acid melting point; selecting an oil effective to reduce a melting point of the aliphatic acid when the aliphatic acid and oil are in mixture; and mixing the aliphatic acid and oil.

In some embodiments, such methods may comprise heating the oil to a temperature greater than the oil melting point prior to mixing and, after the mixing, cooling the oil to below the oil melting point in liquid phase. In some embodiments, such methods may comprise heating the aliphatic acid to a temperature greater than the acid melting point prior to mixing and, after the mixing, cooling the aliphatic acid to below the acid melting point in liquid phase.

Some aspects of the present disclosure provide a method of applying a pesticidal composition to control at least one plant pest, the method comprising providing a pesticidal composition as described herein and applying the pesticidal composition to at least one plant, the locus thereof, or propagation material thereof, which is susceptible to or infested with the at least one plant pest.

In some embodiments, mixing the aliphatic acid with the oil may comprise forming any of the compositions described above. In some further embodiments, the melting point of the aliphatic acid may alternatively or in addition comprise a viscosity transition point of the aliphatic acid, and the pesticidal composition according to such an embodiment may be effective to reduce the viscosity transition point of the aliphatic acid. In yet some further embodiments, the melting point of the oil may alternatively or in addition comprise a viscosity transition point of the oil, and the pesticidal composition according to such an embodiment may be effective to reduce the viscosity transition point of the oil.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a heat flow activity chart for an example sample of substantially pure neem oil.

FIG. 1B is a heat flow activity chart for an example mixture of neem oil and octanoic acid with a mixture ratio of approximately 90:10 by weight.

FIG. 1C is a heat flow activity chart for an example mixture of neem oil and octanoic acid with a mixture ratio of approximately 80:20 by weight.

FIG. 1D is a heat flow activity chart for an example mixture of neem oil and octanoic acid with a mixture ratio of approximately 70:30 by weight.

FIG. 1E is a heat flow activity chart for an example mixture of neem oil and octanoic acid with a mixture ratio of approximately 60:40 by weight.

FIG. 1F is a heat flow activity chart for an example mixture of neem oil and octanoic acid with a mixture ratio of approximately 50:50 by weight.

FIG. 1G is a heat flow activity chart for an example mixture of neem oil and octanoic acid with a mixture ratio of approximately 40:60 by weight.

FIG. 1H is a heat flow activity chart for an example mixture of neem oil and octanoic acid with a mixture ratio of approximately 30:70 by weight.

FIG. 1I is a heat flow activity chart for an example mixture of neem oil and octanoic acid with a mixture ratio of approximately 20:80 by weight.

FIG. 1J is a heat flow activity chart for an example mixture of neem oil and octanoic acid with a mixture ratio of approximately 10:90 by weight.

FIG. 1K is a heat flow activity chart for an example sample of substantially pure octanoic acid.

FIG. 1L is a composite heat flow activity chart showing the charts of FIGS. 1D-1K overlaid.

### DESCRIPTION

### Introductory Generalities

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Unless otherwise defined, all technical and scientific terms used herein have the same meaning as commonly understood by one of ordinary skill in the art to which this invention belongs. Although methods and materials similar or equivalent to those described herein can be used in the practice or testing of the invention, suitable exemplary methods and materials are described herein.

All applications, publications, patents and other references, citations cited herein are incorporated by reference in their entirety. In case of conflict, the specification, including definitions, will control.

As used herein, the singular forms “a”, “and,” and “the” include plural referents unless the context clearly indicates otherwise.

As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth.

As used herein, “plant” embraces individual plants or plant varieties of any type of plants, in particular agricultural, silvicultural and ornamental plants.

As used herein, the terms “pest” or “pests” or grammatical equivalents thereof, are understood to refer to organisms, e.g., including pathogens, that negatively affect a host or other organism—such as a plant or an animal—by colonizing, damaging, attacking, competing with them for nutrients, infesting or infecting them, as well as undesired organisms that infest human structures, dwellings, living spaces or foodstuffs. Pests include but are not limited to fungi, weeds, nematodes, acari, and arthropods, including insects, arachnids and cockroaches. It is understood that the terms “pest” or “pests” or grammatical equivalents thereof can refer to organisms that have negative effects by infesting plants and seeds, and commodities such as stored grain.

As used herein, the terms “pesticide” or “pesticidal” or grammatical equivalents thereof, are understood to refer to any composition or substance that can be used in the control of any agricultural, natural environmental, and domestic/household pests. The terms “control” or “controlling” are meant to include, but are not limited to, any killing, inhibiting, growth regulating, or pestistatic (inhibiting or otherwise interfering with the normal life cycle of the pest) activities of a composition against a given pest. These terms include for example sterilizing activities which prevent the production or normal development of seeds, ova, sperm or spores, cause death of seeds, sperm, ova or spores, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, interfering with mycelial growth, reducing gut motility, inhibiting the formation of chitin, disrupting mating or sexual communication, preventing feeding (antifeedant) activity, and interfering with location of hosts, mates or nutrient-sources. The term “pesticide” includes fungicides, herbicides, nematicides, arthropodicides (e.g. insecticides, arachnicides, acaricides, aphicides, etc.) and the like. The term “pesticide” encompasses, but is not limited to, naturally occurring compounds as well as so-called “synthetic chemical pesticides” having structures or formulations that are not naturally occurring, where pesticides may be obtained by various means including, but not limited to, extraction from biological sources, chemical synthesis of the compound, and chemical modification of naturally occurring compounds obtained from biological sources.

As used herein, the terms “control” or “controlling” or grammatical equivalents thereof, are understood to encompass any pesticidal (killing) activities or pestistatic (inhibiting, repelling, deterring, and generally interfering with pest functions to prevent the damage to the host plant) activities of a pesticidal composition against a given pest. Thus, the terms “control” or “controlling” or grammatical equivalents thereof, not only include killing, but also include such activities as repelling, deterring, inhibiting or killing egg development or hatching, inhibiting maturation or development, and chemisterilization of larvae or adults. Repellant or deterrent activities may be the result of compounds that are poisonous, mildly toxic, or non-poisonous to pests, or may act as pheromones in the environment.

As used herein, the term “pesticidally effective amount” generally means the amount of the inventive mixtures or of compositions comprising the mixtures needed to achieve an observable effect on growth, including the effects of necrosis, death, retardation, prevention, and removal, destruction, or otherwise diminishing the occurrence and activity of the target pest organism. The pesticidally effective amount can vary for the various mixtures/compositions used in the invention. A pesticidally effective amount of the mixtures/compositions will also vary according to the prevailing conditions such as desired pesticidal effect and duration, weather, target species, locus, mode of application, and the like.

As used herein, the terms “eutectic” (and related terms such as “eutectic mixture”) generally refer to homogeneous mixtures of two or more ingredients where the melting point of the mixture is less than the melting points of each of the two or more ingredients. The mixture may be a constituent of another mixture, and thus may itself be mixed with other ingredients (which may have melting points above or below the melting point of the eutectic mixture) and still be considered eutectic for the purposes of this disclosure and the appended claims. Otherwise put, the eutectic mixture may optionally comprise further ingredients which do not necessarily contribute to the eutectic relationship of the two or more ingredients without diverging from the meaning of “eutectic” as used herein. The melting point of the mixture is not necessarily the lowest possible melting point achieved by an optimal mixture ratio of the two or more ingredients (sometimes called the “eutectic point”); although such mixtures are encompassed by the meaning of “eutectic” as used herein, any mixture with ingredients capable of forming a eutectic system and which has a melting point less than the melting points of two or more ingredients is “eutectic” for the purposes of this disclosure and the appended claims. In one aspect, the melting point of such a mixture may alternatively or in addition comprise a eutectic viscosity transition point, and the eutectic viscosity transition point may be less than the corresponding viscosity transition points of two or more of the ingredients of the mixture.

As used herein, where a range of values is provided, it is understood that each intervening value, to the tenth of the unit of the lower limit unless the context clearly dictates otherwise, between the upper and lower limit of that range and any other stated or intervening value within that stated range is encompassed within embodiments of the invention. The upper and lower limits of these smaller ranges may independently define a smaller range of values, and it is to be understood that these smaller ranges are intended to be encompassed within embodiments of the invention, subject to any specifically excluded limit in the stated range.

### Enhanced Pesticidal Compositions

In some aspects of the present invention, novel pesticidal compositions are disclosed comprising an oil having an oil melting point and an aliphatic acid having an acid melting point. The aliphatic acid and oil form a mixture in which the aliphatic acid is effective to reduce the mixture's melting point to below the oil melting point and/or the oil is effective to reduce the mixture's melting point to below the aliphatic acid melting point. In some embodiments, the mixture comprises a eutectic mixture of the aliphatic acid and the oil wherein the melting point of the mixture is less than both the oil melting point and the acid melting point.

Certain oils tend to have relatively high melting points and/or otherwise can undergo an oil-to-fat transition (e.g. via winterization) at relatively high temperatures. This can present challenges in transportation and/or application of the pesticidal composition. In some embodiments, a pesticidal composition comprising an oil is enhanced by mixing the oil with an aliphatic acid (e.g. one described below) which is effective to reduce the melting point of the mixture to below the oil's melting point. For example, the aliphatic acid and oil may form a eutectic mixture with a eutectic point below both the oil's melting point and the aliphatic acid's melting point. In some aspects, an oil may have a relatively high viscosity transition point, where the viscosity of the oil increases above a critical point, such as above a point which may no longer allow pouring of the oil for example, at an undesirably high temperature. In one such aspect, a pesticidal composition comprising such an oil may desirably be enhanced by mixing the oil with an aliphatic acid which is effective to reduce the viscosity transition point, such as a pour point for example, of the oil. In a particular such example, the oil and aliphatic acid may desirably form a eutectic mixture with a eutectic viscosity transition point below both the oil's viscosity transition point, and at least one of the melting or viscosity transition point of the aliphatic acid, for example.

Certain aliphatic acids have relatively high melting points, which can present challenges for pesticidal compositions comprising such aliphatic acids similar to the challenges described above. In some embodiments, a pesticidal composition comprising an aliphatic acid is enhanced by mixing the aliphatic acid with an oil (e.g. one described below) which is effective to reduce the melting point of the mixture to below the aliphatic acid's melting point. For example, the aliphatic acid and oil may form a eutectic mixture with a eutectic point below both the oil's melting point and the aliphatic acid's melting point. In some aspects, an aliphatic acid may have a relatively high viscosity transition point, where the viscosity of the aliphatic acid increases above a critical point, such as may allow pouring of the aliphatic acid for example, at an undesirably high temperature. In one such aspect, a pesticidal composition comprising such an aliphatic acid may desirably be enhanced by mixing the aliphatic acid with pesticidal oil which is effective to reduce the viscosity transition point, such as a pour point for example, of the aliphatic acid. In a particular such example, the aliphatic acid and oil may desirably form a eutectic mixture with a eutectic viscosity transition point below both the aliphatic acid's viscosity transition point, and at least one of the melting or viscosity transition point of the oil, for example.

In some embodiments, the oil comprises a pesticidal oil. In some embodiments, the oil is a pesticidal natural or essential oil and/or an oil extract, constituent and/or derivative thereof. For example, the oil may comprise a pesticidal natural oil selected from: neem oil, karanja oil, clove oil, clove leaf oil, peppermint oil, spearmint oil, mint oil, cinnamon oil, thyme oil, oregano oil, rosemary oil, geranium oil, lime oil, lavender oil, anise oil, lemongrass oil, tea tree oil, apricot kernel oil, bergamot oil, carrot seed oil, cedar leaf oil, citronella oil, clove bud oil, coriander oil, coconut oil, eucalyptus oil, evening primrose oil, fennel oil, ginger oil, grapefruit oil, nootkatone(+), grapeseed oil, lavender oil, marjoram oil, pine oil, scotch pine oil, garlic oil, and/or safflower oil and/or constituents, derivatives and/or extracts of one or more pesticidal natural oil, or a combination thereof.

In other embodiments, the pesticidal natural oil may comprise any natural oil or oil mixture that includes one or more constituents common to two or more of the pesticidal natural oils listed above (e.g. neem oil, karanja oil, clove oil, peppermint oil, cinnamon oil, thyme oil, oregano oil, garlic oil, anise oil, geranium oil, lime oil, lavender oil), including, but not limited to, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others). In other embodiments, the pesticidal natural oil may comprise any oil having as a constituent one of the following compounds, or a combination of the following compounds: azadirachtin, nimbin, nimbinin, salannin, gedunin, karanjin, pongamol, geraniol, geranial, gamma-terpinene, alpha-terpineol, beta-caryophyllene, terpinen-4-ol, myrcenol-8, thuyanol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cineole, eugenol, limonene, alpha-pinene, menthol, menthone, and linalool.

In further embodiments, the pesticidal natural oil may comprise one or more suitable plant essential oils or extracts or fractions thereof disclosed herein including, without limitation: alpha- or beta-pinene; alpha-campholenic aldehyde; alpha.-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lambda-terpinene; achillea; aldehyde C16 (pure); allicin; alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., Dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; Citrus unshiu; clary sage; clove (e.g., Eugenia caryophyllus); clove bud; coriander; corn; cotton seed; d-dihydrocarvone; decyl aldehyde; diallyl disulfide; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); Eucalyptus citriodora; Eucalyptus globulus; eucalyptus; eugenol (e.g., 2-methoxy-4-allyl phenol); evening primrose; fenchol; fennel; ferniol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linalool oxide; linalool; linalyl acetate; linseed; Litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., Myristica fragrans); orange (e.g., Citrus aurantium dulcis); orris (e.g., Iris florentina) root; para-cymene; para-hydroxy phenyl butanone crystals (e.g., 4-(4-hydroxphenyl)-2-butanone); passion palmarosa oil (e.g., Cymbopogon martini); patchouli (e.g., Pogostemon cablin); p-cymene; pennyroyal oil; pepper; peppermint (e.g., Mentha piperita); perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis); ryu; sage; sandalwood (e.g., Santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, and the like.

In some embodiments, the oil comprises a fatty acid ester, such as a wax ester. For example, the oil may comprise a fatty acid ester (e.g. a wax ester) extracted, fractionated or derived from one or more oils described above, without necessarily including other constituents and/or fractions of such oils (and/or partially including some such constituents and/or fractions and excluding others). In certain oils (such as neem oil), fatty acid ester constituents, and particularly wax ester constituents, have been observed experimentally to be the principal contributor to solidification at relatively high temperatures (e.g. on the order of 30° C. in the case of neem oil). Accordingly, mixing such oils (e.g. neem oil) with aliphatic acids effective to reduce a melting point of the resulting mixture (e.g. via eutectic interaction) can reduce the overall melting point, and/or viscosity transition point, of the oil, and thus enhance a pesticidal composition comprising the oil.

Without being bound by any particular theory, it is believed that in at least some embodiments the ester group of at least some fatty acid esters (e.g. wax esters) have compatible polarity with the acid group of at least some aliphatic acids, and that further the geometry of aliphatic acids promotes interference with lamellar crystallization structures formed during solidification of such fatty acid esters (and vice-versa). The net result, in at least some embodiments, is promotion of the formation of eutectic mixtures between at least some fatty acid esters and at least some aliphatic acids.

In some embodiments, the aliphatic acid comprises a saturated or unsaturated aliphatic acid (also known as a fatty acid). In some embodiments, the aliphatic acid has a carbon chain length no greater than 12 carbon atoms. For example, the aliphatic acid may comprise a C6-C12 fatty acid, including a C7, C8, C9, C10 or C11 fatty acid. As another example, the aliphatic acid may comprise a C6-C10 fatty acid. In some embodiments, the aliphatic acid comprises a naturally occurring aliphatic acid, such as may be present in, or extracted, fractionated or derived from a natural plant or animal material. For example, the aliphatic acid may comprise one or more naturally occurring aliphatic acids provided in a plant extract or fraction thereof. As another example, the aliphatic acid may comprise one or more naturally occurring aliphatic acids provided in an animal extract or product, or fraction thereof. In some embodiments, the aliphatic acid may comprise a naturally occurring aliphatic acid comprised in a plant oil extract, such as one or more of coconut oil, palm oil, palm kernel oil, corn oil, or fractions or extracts therefrom. In some such embodiments, the aliphatic acid may comprise a naturally occurring aliphatic acid comprised in an animal extract or product, such as one or more of cow's milk, goat's milk, beef tallow, and/or cow or goat butter, or fractions or extracts therefrom. In at least one embodiment, the aliphatic acid is provided as a component of one or more natural plant or animal material, or extract or fraction thereof. In at least one embodiment, the aliphatic acid is provided in an extract or fraction of one or more plant oil extract, such as one or more of coconut oil, palm oil, palm kernel oil, corn oil, or fractions or extracts therefrom.

The aliphatic acid may comprise cis or trans isomers, may be saturated or unsaturated, may comprise branched or unbranched carbon chains, and/or may comprise any combination thereof (including combinations of different aliphatic acids, e.g. in mixture). For example, unsaturated aliphatic acids may comprise at least one of: a trans-unsaturated C—C bond, a cis-unsaturated C—C bond, and/or a plurality of conjugated unsaturated C—C bonds. As another example unsaturated aliphatic acids may comprise at least one of: a trans-2, trans-3, trans-4, trans-5, trans-6, trans-7, trans-8, and trans-9, cis-2, cis-3, cis-4, cis-5, cis-6, cis-7, cis-8, and cis-9 unsaturated bond (e.g. hexanoic acid, octanoic acid, decanoic acid, and/or oleic acid).

In at least some embodiments, a weight ratio of the oil to the aliphatic acid is between about 90:10 and 10:90. Experimental observations indicate that this range encompasses eutectic combinations of diverse mixtures of oils and aliphatic acids. Mixtures of certain oils and aliphatic acids provided eutectic properties in certain mixture ratio subranges. In general, eutectic properties were observed for at least the following weight ratios of oil to aliphatic acid: 90:10 and 20:80; 90:10 and 30:70; 90:10 and 40:60; 90:10 and 50:50; 90:10 and 60:40; 90:10 and 70:30; 90:10 and 80:20; 80:20 and 10:90; 80:20 and 20:80; 80:20 and 30:70; 80:20 and 40:60; 80:20 and 50:50; 80:20 and 60:40; 80:20 and 70:30; 70:30 and 10:90; 70:30 and 20:80; 70:30 and 30:70; 70:30 and 40:60; 70:30 and 50:50; 70:30 and 60:40; 60:40 and 10:90; 60:40 and 20:80; 60:40 and 30:70; 60:40 and 40:60; 60:40 and 50:50; 50:50 and 10:90; 50:50 and 20:80; 50:50 and 30:70; and 50:50 and 40:60. Experimental results below may show further ranges exhibiting eutectic properties.

For example, when palm oil, coconut oil, and karanja oil were each individually mixed with octanoic acid, weight ratios of oil to octanoic acid of between about 90:10 and 60:40, 90:10 and 70:30, 90:10 and 80:20, 80:20 and 60:40, 80:20 and 70:30, and 70:30 and 60:40 provided eutectic properties. Data from at least some such experiments are provided as examples below.

Several experiments were carried out with neem oil. For example, when neem oil was mixed with oleic acid, weight ratios of neem oil to oleic acid of between about 80:20 and 40:60, 80:20 and 50:50, 80:20 and 60:40, 80:20 and 70:30, 70:30 and 40:60, 70:30 and 50:50, 70:30 and 60:40, 60:40 and 40:60, 60:40 and 50:50, and 50:50 and 40:60 provided eutectic properties. As another example, when neem oil was mixed with trans 3 hexenoic acid, weight ratios of neem oil to trans 3 hexenoic acid of between about 80:20 and 60:40, 80:20 and 70:30, and 70:30 and 60:40 provided eutectic properties. As yet another example, when neem oil was mixed with decanoic acid, a weight ratio of neem oil to decanoic acid of between about 90:10 and 80:20 provided eutectic properties. As a final example, when neem oil was mixed with octanoic acid a weight ratio of neem oil to octanoic acid of between about 80:20 and 70:30 provided eutectic properties. Data from at least some such experiments are provided as examples below.

In some embodiments, the oil comprises a dormant oil, such as for application to trees. Dormant oils are often applied in cooler temperatures and thus can be sensitive to melting point. For this reason, oils with low melting points (e.g. mineral oils, refined petroleum oils) are often used for dormant oil applications. However, in some embodiments, the dormant oil comprises an oil having a relatively high melting point for conventional dormant application (e.g. in excess of 0° C., 5° C., 10° C., 15° C., and/or 20° C.). When the dormant oil is combined with an aliphatic acid as described herein, the resulting pesticidal composition may, in suitable circumstances, have a melting point suitable for dormant application.

The pesticidal composition comprises one or more pesticidal active ingredients in a pesticidally effective amount. In some embodiments, the one or more pesticidal active ingredients comprises a pesticidal oil, a pesticidal aliphatic acid, and/or a pesticidal combination thereof. In such embodiments, one or both of the oil and the aliphatic acid may provide pesticidal efficacy alone or in combination. For example, the oil and/or the aliphatic acid (alone or in combination) may be fungicidal, nematicidal, arthropodicidal, ovicidal, miticidal, herbicidal and/or otherwise pesticidal. For instance, various pesticidal oils (e.g. neem oil) are disclosed above and may provide the pesticidal composition with pesticidal efficacy. In some embodiments, the pesticidal active ingredient may comprise a further ingredient (in addition to the oil and aliphatic acid, which are not necessarily pesticidal in such embodiments) which provides pesticidal efficacy, either alone or in combination with one or more of the oil and aliphatic acid. For example, the composition may comprise a synthetic pesticide such as Chlorfenapyr (a halogenated pyrrole synthetic miticide-insecticide) as well as an oil and an aliphatic acid as described elsewhere herein.

### Other Formulation Ingredients

In some embodiments, when the pesticidal compositions disclosed in this disclosure comprise and/or are used in a formulation, such formulation may also contain other constituents. These constituents include, but are not limited to, wetters, spreaders, stickers, penetrants, buffers, sequestering agents, drift reduction agents, compatibility agents, anti-foam agents, cleaning agents, rheology modifying agents, stabilizers, dispersing agents, emulsifiers, surfactants, diluents, and/or carriers. Several exemplary such additional formulation components are described below.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulphate; sodium dioctyl sulphosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulphonates; sodium naphthalene sulphonate formaldehyde condensates; tristyrylphenol ethoxylate phosphate esters; aliphatic alcohol ethoxylates; alkyl ethoxylates; EO-PO block copolymers; and graft copolymers. Further examples of surfactants that can be used in some embodiments of the present disclosure include, but are not limited to sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, ethoxylated alkylphenols, fatty esters, sodium dodecylsulfide, other natural or synthetic surfactants, and combinations thereof. In some embodiments, the surfactant(s) are non-ionic surfactants. In some embodiments, the surfactant(s) are cationic or anionic surfactants. In some embodiments, a surfactant may comprise two or more surface active agents used in combination. The selection of an appropriate surfactant depends upon the relevant applications and conditions of use, and selection of appropriate surfactants are known to those skilled in the art.

An emulsifying agent is a substance which stabilizes a suspension of droplets of one liquid phase in another liquid phase. Without the emulsifying agent the two liquids would typically separate into two immiscible liquid phases. Exemplary commonly used emulsifier blends may contain alkylphenol or aliphatic alcohol with 12 or more ethylene oxide units and the oil-soluble calcium salt of dodecylbenzene sulphonic acid for example. In some embodiments, a range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. Exemplary types of surfactants usually used for solubilization include non-ionics: sorbitan monooleates; sorbitan monooleate ethoxylates; and methyl oleate esters.

Thickeners or gelling agents may be typically used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. In some examples, it is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol, polyethylene oxide and xanthan gum.

The presence of surfactants, which lower interfacial tension, often causes water-based formulations to foam during mixing operations in production and in application of a pesticidal composition through a spray tank. In order to reduce the tendency to foam, anti-foam agents are often added either during the production stage or before filling into bottles. Generally, there are two types of anti-foam agents, namely silicones and non-silicones. Silicones may usually comprise aqueous emulsions of dimethyl polysiloxane while the non-silicone anti-foam agents comprise water-insoluble oils, such as octanol and nonanol, or silica. In both cases, the function of the anti-foam agent is to displace the surfactant from the air-water interface.

In some embodiments such formulations may comprise one or more suitable carrier or diluent components. A suitable carrier or diluent component can be selected by one skilled in the art, depending on the particular application desired and the conditions of use of the composition. Commonly used carriers and diluents may include ethanol, isopropanol, isopropyl myristate, other alcohols, water and other inert carriers, such as but not limited to those listed by the EPA as a Minimal Risk Inert Pesticide Ingredients (4A) (the list of ingredients published dated December 2015 by the US EPA FIFRA 4a list published August 2004 entitled “List 4A—Minimal Risk Inert Ingredients”) or, for example, Inert Pesticide Ingredients (4B) (the US EPA FIFRA 4b list published August 2004 entitled “List 4B—Other ingredients for which EPA has sufficient information”) or under EPA regulation 40 CFR 180.950 dated May 24, 2002, each of which is hereby incorporated herein in its entirety for all purposes including for example, citric acid, lactic acid, glycerol, castor oil, benzoic acid, carbonic acid, ethoxylated alcohols, ethoxylated amides, glycerides, benzene, butanol, 1-propanol, hexanol, other alcohols, dimethyl ether, and polyethylene glycol.

For further information on suitable such other formulation components known to those of skill in the art, reference may be made to publications such as, for example: “CHEMISTRY AND TECHNOLOGY OF AGROCHEMICAL FORMULATIONS” edited by D. A. Knowles, copyright 1998 by Kluwer Academic Publishers; and/or: “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

### Methods for Enhancing Pesticidal Compositions

Aspects of the present disclosure comprise methods for making and/or enhancing pesticidal compositions. The pesticidal composition may comprise, for example, a fungicide, nematicide, insecticide, and/or other type of pesticide. In some aspects, the methods involve mixing an oil having an oil melting point and an aliphatic acid having an acid melting point. In some embodiments, the aliphatic acid is effective to reduce at least the melting point of the oil in the pesticidal composition to below the oil melting point (which here refers to a melting point of the oil when not mixed with the aliphatic acid). In some embodiments, the oil is effective to reduce at least the melting point of the aliphatic acid in the pesticidal composition to below the acid melting point (which here refers to a melting point of the aliphatic acid when not mixed with the oil). In some embodiments, the melting point of the mixture formed by the oil and the aliphatic acid has a mixture melting point which is less than the oil and acid melting points. Either one (or both) of the oil and aliphatic acid are effective to reduce the mixture melting point, e.g. by reducing a melting point of at least the aliphatic acid or oil (respectively) as described above.

In some other embodiments, the methods may involve mixing an oil having an oil viscosity transition point, such as a pour point, with an aliphatic acid having an acid viscosity transition point, such as a pour point. In some such embodiments, the aliphatic acid is effective to reduce at least the viscosity transition point of the oil in the pesticidal composition to below the oil viscosity transition point (which here refers to the viscosity transition point of the oil when not mixed with the aliphatic acid). In some embodiments, the oil is effective to reduce at least the viscosity transition point of the aliphatic acid in the pesticidal composition to below the acid viscosity transition point (which here refers to a viscosity transition point of the aliphatic acid when not mixed with the oil). In some embodiments, the viscosity transition point of the mixture formed by the oil and the aliphatic acid has a mixture viscosity transition point which is less than the oil and acid viscosity transition points. Either one (or both) of the oil and aliphatic acid are effective to reduce the mixture viscosity transition point, e.g. by reducing a viscosity transition point of at least the aliphatic acid or oil (respectively) as described above.

In some embodiments, mixing the oil and aliphatic acid comprises forming a eutectic mixture with a eutectic point (such as a eutectic melting point or eutectic viscosity transition point, for example) below both the oil's melting point and the aliphatic acid's melting point (or viscosity transition points, respectively). As noted elsewhere herein, the mixture melting point (or viscosity transition point) may be, but is not necessarily, the eutectic point, i.e. the lowest melting point (or viscosity transition point) achieved by any mixture ratio of the oil and aliphatic acid (achieved at what is sometimes called the eutectic percentage ratio). Without being bound by any particular theory, this may be due to the eutectic mixture itself being mixed with further compounds which affect its melting point or viscosity transition point (e.g. a pour point depressant), having a mixture ratio between the oil and aliphatic acid which is not precisely the eutectic percentage ratio, and/or other reasons.

In some embodiments, methods for making and/or enhancing a pesticidal composition comprises providing one or more pesticidal active ingredients in a pesticidally effective amount. In some embodiments, providing one or more pesticidal active ingredients comprises providing a pesticidal oil, a pesticidal aliphatic acid, and/or a pesticidal combination thereof. In such embodiments, one or both of the oil and the aliphatic acid may provide pesticidal efficacy alone or in combination. For example, the oil and/or the aliphatic acid (alone or in combination) may be fungicidal, nematicidal, arthropodicidal, ovicidal, miticidal, herbicidal and/or otherwise pesticidal. In some embodiments, the oil and aliphatic acid are combined with one or more further ingredients to provide pesticidal efficacy. For example, the pesticidal composition may comprise a pesticidal active ingredient (in addition to the oil and aliphatic acid, which are not necessarily pesticidal in such embodiments). Making the pesticidal composition may comprise providing a pesticidally effective amount of the pesticidal active ingredient (optionally in a formulation comprising one or both of the oil and aliphatic acid) and mixing the oil and aliphatic acid to reduce the melting point (or viscosity transition point) of the resulting mixture of oil and aliphatic acid (e.g. by mixing one or both of the oil and aliphatic acid with a formulation comprising the pesticidal active ingredient; as noted above, the formulation may optionally comprise one or both of the oil and aliphatic acid).

In some embodiments, a method of enhancing a pesticidal composition comprises enhancing a pesticidal composition comprising an oil and involves mixing an aliphatic acid with the oil (e.g. by mixing the aliphatic acid with the pesticidal composition). The aliphatic acid is effective to reduce a melting point (or viscosity transition point) of at least the oil in the pesticidal composition. In some embodiments, the method alternatively or additionally comprises enhancing a pesticidal composition comprising an aliphatic acid and involves mixing an oil with the aliphatic acid (e.g. by mixing the oil with the pesticidal composition). The aliphatic acid is effective to reduce a melting point (or viscosity transition point) of at least the oil in the pesticidal composition. The melting points of one or more other constituents of the pesticidal composition may optionally be (but are not necessarily) affected by mixing the oil/aliphatic acid.

In some embodiments, the methods disclosed herein comprise heating the oil to a temperature greater than the oil melting point (or viscosity transition point) prior to mixing. In some embodiments, the method alternatively or additionally comprises heating the aliphatic acid to a temperature greater than the acid melting point (or viscosity transition point) prior to mixing. After mixing, the oil and/or aliphatic acid is cooled to below the respective melting point (or viscosity transition point) in liquid phase. For example, the pesticidal composition may be cooled to below the oil and acid melting points in liquid phase. The pesticidal composition may optionally be further cooled below the melting point (or viscosity transition point) of one or more constituents prior to application, but in at least some embodiments the pesticidal composition is maintained in liquid phase from formulation until application.

Aspects of the present disclosure comprise a method for enhancing a pesticidal composition by providing an oil having an oil melting point (or viscosity transition point), selecting an aliphatic acid effective to reduce a melting point (or viscosity transition point) of the oil when the aliphatic acid and oil are in mixture, and mixing the aliphatic acid and oil. Alternatively, or in addition, the method for enhancing a pesticidal composition may comprise providing an aliphatic acid having an acid melting point (or viscosity transition point), selecting an oil effective to reduce a melting point (or viscosity transition point) of the aliphatic acid when the aliphatic acid and oil are in mixture, and mixing the aliphatic acid and oil. The method may comprise reducing melting points (or viscosity transition points) of both the aliphatic acid and oil when in mixture to below their respective melting points (or viscosity transition points) when out of mixture.

Aspects of the present disclosure comprise methods for controlling at least one plant pest. The methods comprise providing a pesticidal composition as disclosed herein (e.g. via the methods of making and/or enhancing a pesticidal composition disclosed herein) and controlling at least one plant pest by applying the pesticidal composition to at least one plant, the locus thereof, or propagation material thereof, which is susceptible to or infested with the at least one plant pest. For example, such a method may comprise providing a fungicidal composition comprising a fungicidal oil, a fungicidal aliphatic acid, a separate fungicidal active ingredient, and/or a fungicidal combination of the oil, aliphatic acid, and/or separate fungicidal active ingredient, and exposing a fungus to the resulting fungicidal composition. As another example, such a method may comprise providing a nematocidal composition comprising a nematocidal oil, a nematocidal aliphatic acid, a separate nematocidal active ingredient, and/or a nematocidal combination of the oil, aliphatic acid, and/or separate nematocidal active ingredient, and exposing a nematode to the resulting nematocidal composition. As yet another example, such a method may comprise providing an insecticidal composition comprising an insecticidal oil, an insecticidal aliphatic acid, a separate insecticidal active ingredient, and/or an insecticidal combination of the oil, aliphatic acid, and/or separate insecticidal active ingredient, and exposing an insect to the resulting insecticidal composition. In some embodiments, the plant comprises a tree and application comprises applying the pesticidal composition comprising the oil to the tree as a dormant oil (e.g. by spraying the pesticidal composition on at least a portion of a tree, such as the trunk, branches, and/or leaves).

### Applications and Example Formulations

In some embodiments, the actual amount of a pesticidal composition to be applied to loci of pests may generally not be critical and can readily be determined by those skilled in the art through experience and/or trial and error in application rates, for example. In general, concentrations within a range of about 0.01 grams of pesticidal active ingredient per hectare to about 5000 grams of pesticidal active ingredient per hectare may commonly be used to establish a desired range of application rates expected to provide good control.

In some embodiments, a “tank-mix” formulation is provided for mixing with a target pesticidal composition. Such a formulation may comprise, for example, a carrier miscible with the target pesticidal composition, an aliphatic acid and/or an oil (for combination with a pesticidal composition comprising an oil or an aliphatic acid, respectively), and, optionally, an emulsifier. For instance, such a formulation may comprise a mixture which is approximately 22% octanoic acid (an aliphatic acid), 15% emulsifier (such as an emulsifier described in U.S. Provisional Patent Application No. 62/787,175, incorporated herein by reference), and 63% safflower oil (and/or other suitable oil-miscible carrier compatible with the aliphatic acid). As another example, such a formulation may comprise a mixture which is approximately 13.2% octanoic acid, 8.8% decanoic acid, 15% emulsifier (such as an emulsifier described in U.S. Provisional Patent Application No. 62/787,175, incorporated herein by reference), and 63% safflower oil (and/or other suitable oil-miscible carrier compatible with the aliphatic acid).

Such tank-mix formulations may be combined with suitable commercially-available target pesticidal compositions. For example, a tank-mix formulation comprising an aliphatic acid (such as either of the two foregoing example formulations) may be combined with an oil-based target pesticidal composition in sufficient quantity to reduce the melting point (or viscosity transition point) of the resulting mixture of target pesticidal composition and tank-mix formulation. In particular, the tank-mix formulation may be added to the pesticidal composition (or vice versa) in sufficient quantity to provide a desired ratio of aliphatic acid (e.g. octanoic acid, decanoic acid, and/or any other suitable acid described herein) to the oil of the target pesticidal composition, thereby reducing a melting point (or viscosity transition point) of at least the oil in the target pesticidal composition.

In some embodiments, one or more of the carrier, emulsifier, and aliphatic acid and/or oil is at least one of: organic, certified organic, US Department of Agriculture (“USDA”) National Organic Program compliant (“NOP-compliant”) such as may be included in the US Environmental Protection Agency FIFRA 25b list of ingredients published dated December 2015 by the US EPA entitled “Active Ingredients Eligible for Minimum Risk Pesticide Products” and incorporated by reference herein in its entirety for all purposes, the US EPA FIFRA 4a list published August 2004 entitled “List 4A—Minimal Risk Inert Ingredients” or the US EPA FIFRA 4b list published August 2004 entitled “List 4B—Other ingredients for which EPA has sufficient information”, for example, Organic Materials Review Institute listed (“OMRI-listed”), or natural ingredient. The two foregoing example formulations are examples of formulations where all ingredients may be NOP-compliant.

### EXAMPLES

Exemplary embodiments of the present invention are further described with reference to the following examples, which are intended to be illustrative and non-limiting in nature.

### Example 1—Neem Oil and Octanoic Acid

Eleven exemplary pesticidal compositions, each comprising a different mixture ratio of neem oil and octanoic acid, were prepared according to the following description. Each composition comprised a combined 10-20 mg of cold-pressed neem oil and octanoic acid. The neem oil and octanoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of neem oil and 4 mg of octanoic acid. The mixture's melting point was then measured by a differential scanning calorimeter (DSC), and particularly by a TA Instruments® DSC Q2000™ differential scanning calorimeter. The following method was used for DSC measurement of each mixture: the mixture was equilibrated at 40° C., then isothermally held for 15 minutes, then equilibrated at −30° C., and then ramped at 5° C./minute to 70° C. The compositions of the resulting pesticidal composition are therefore as shown below in Table 1:

TABLE 1
Pesticidal Compositions of Example 1

| | Neem oil:octanoic acid | | |
|---|---|---|---|
| Mixture | mixture ratio | Melting Point | |
| 1 | 100% neem oil | Plateau range | |
| 2 | 90:10 | Plateau range | |
| 3 | 80:20 | Plateau range | |
| 4 | 70:30 | 4.3° | C. |
| 5 | 60:40 | 6.99° | C. |
| 6 | 50:50 | 9.08° | C. |
| 7 | 40:60 | 11.55° | C. |
| 8 | 30:70 | 13.17° | C. |
| 9 | 20:80 | 14.51° | C. |
| 10 | 10:90 | 15.56° | C. |
| 11 | 100% octanoic acid | 16.13° | C. |

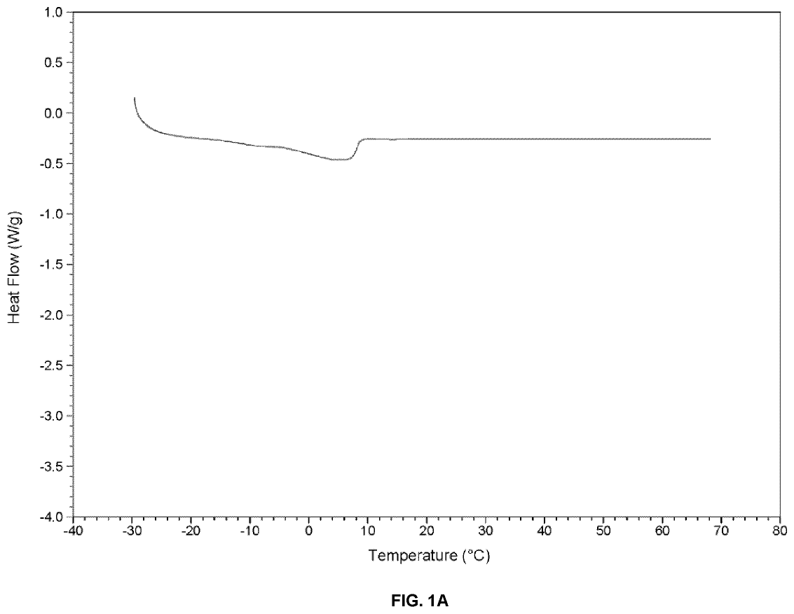

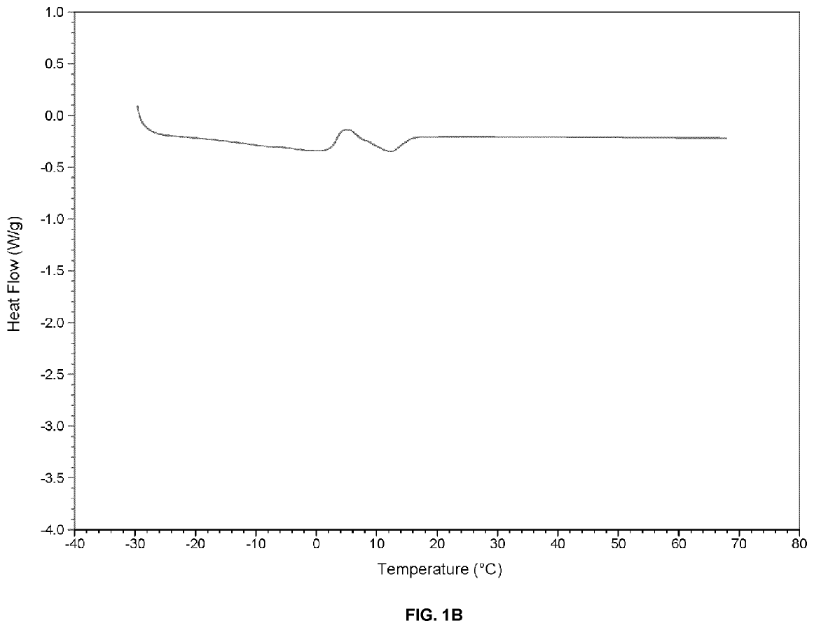

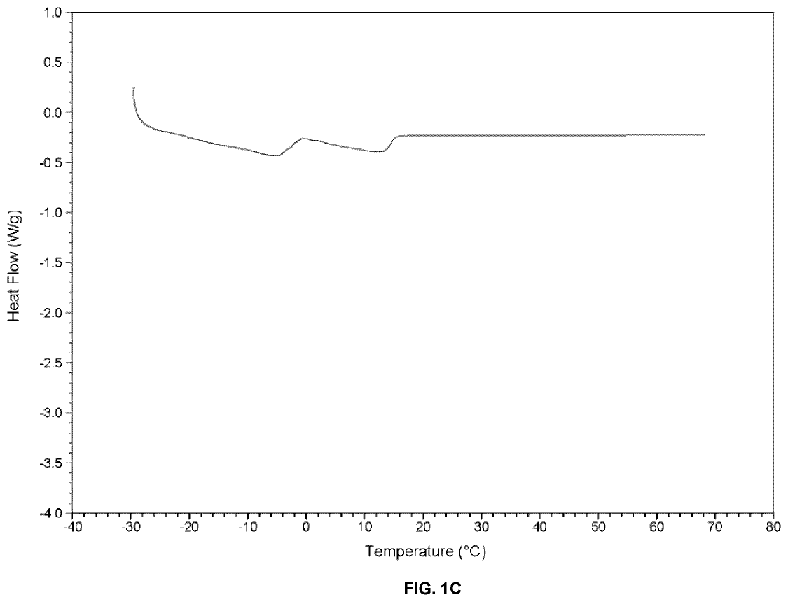

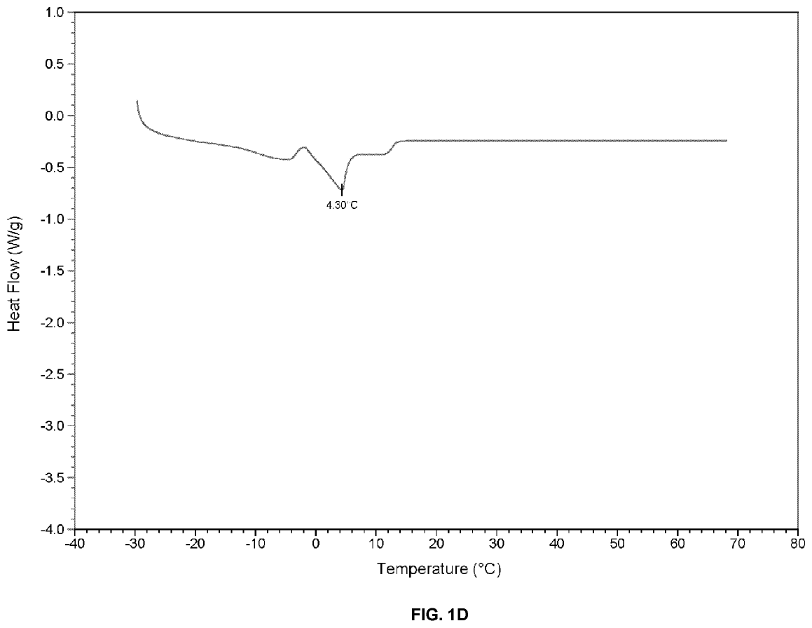

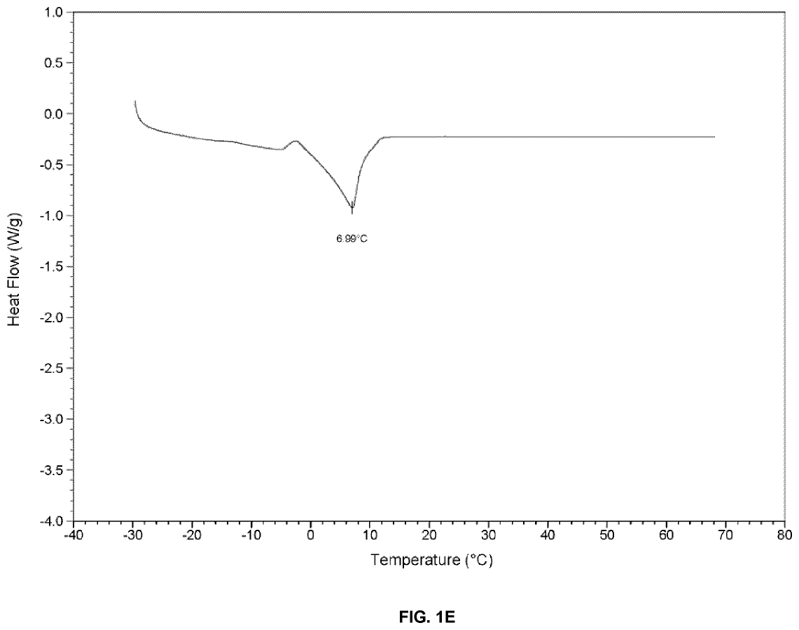

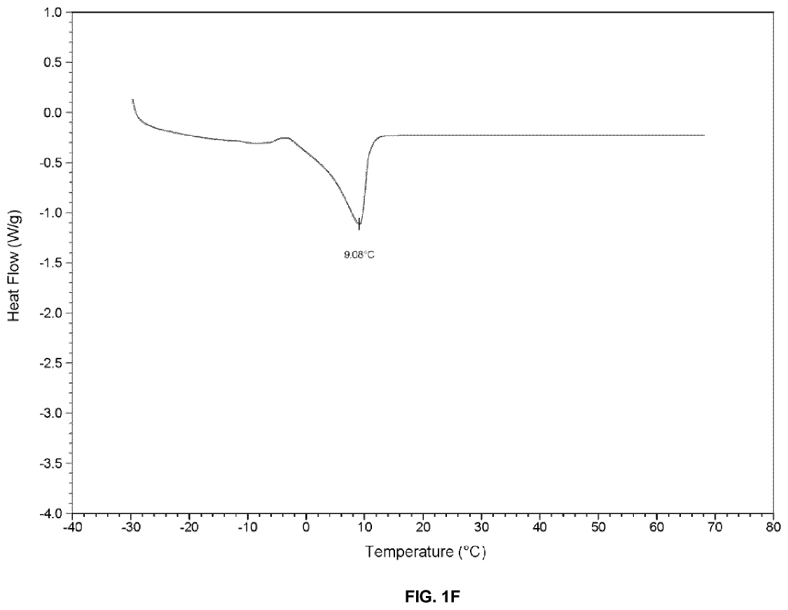

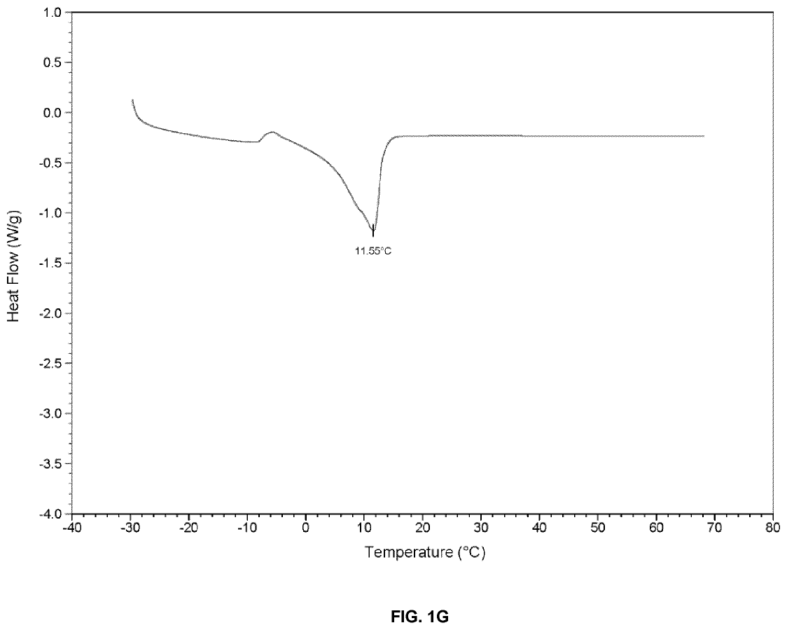

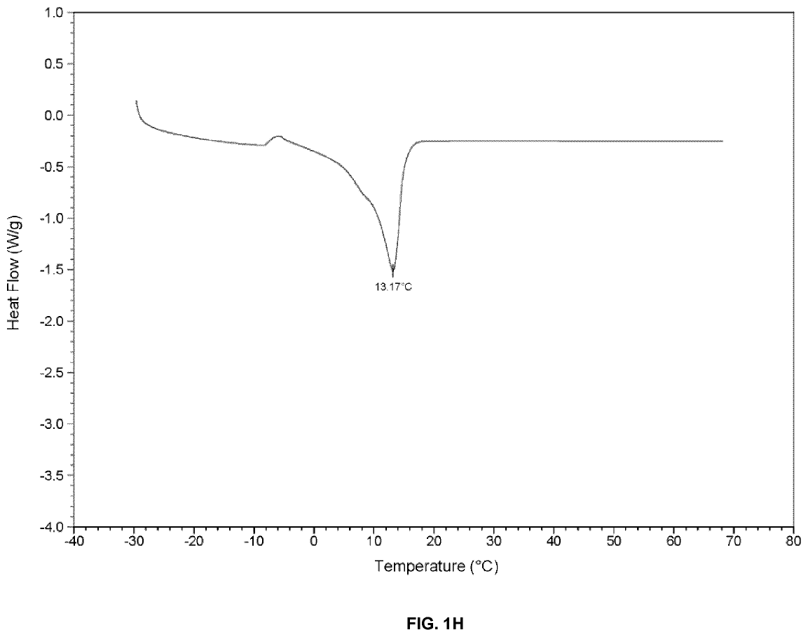

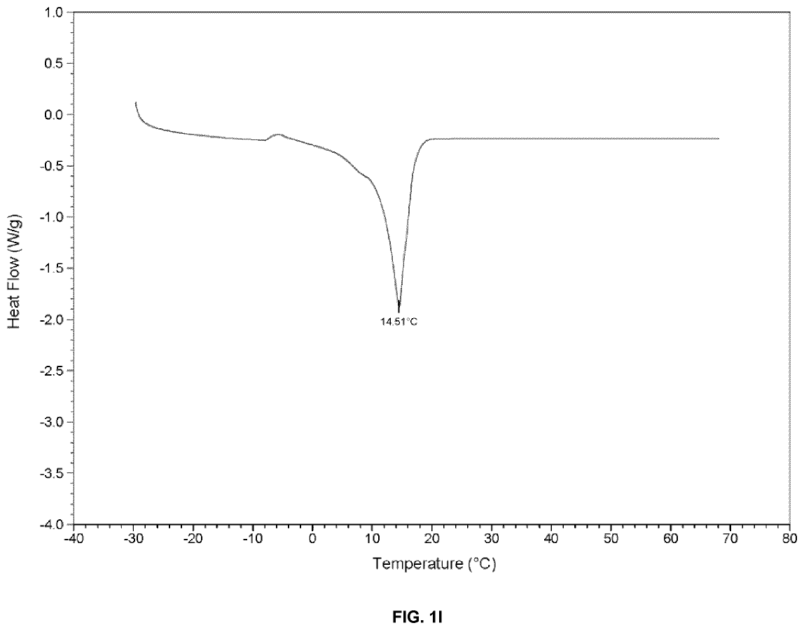

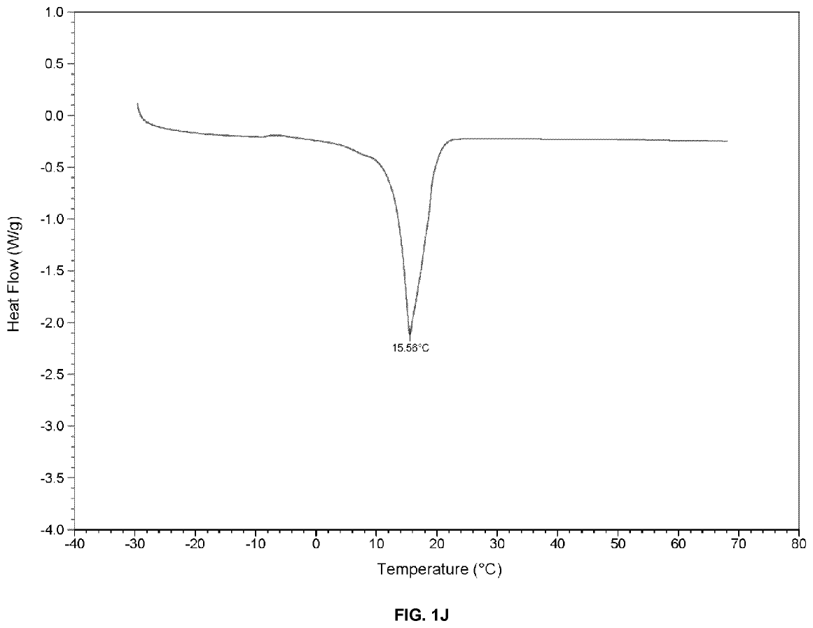

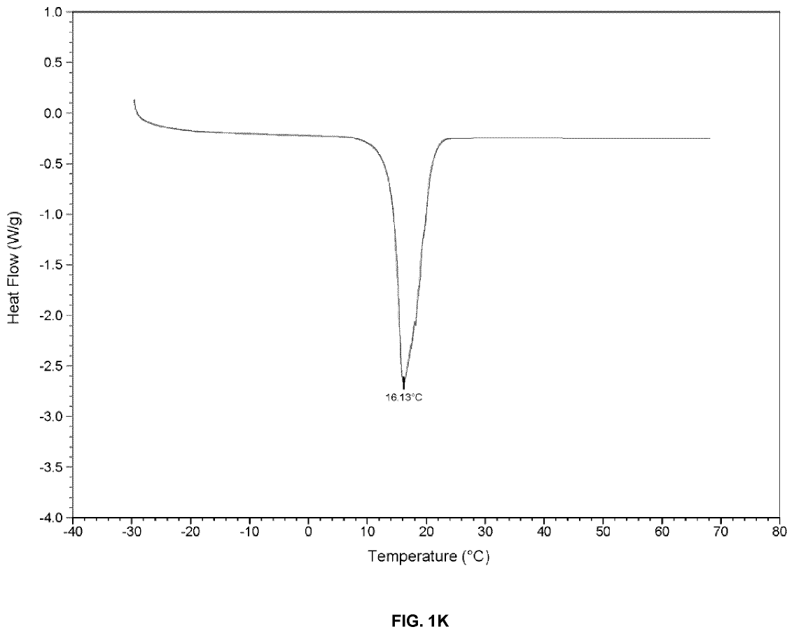

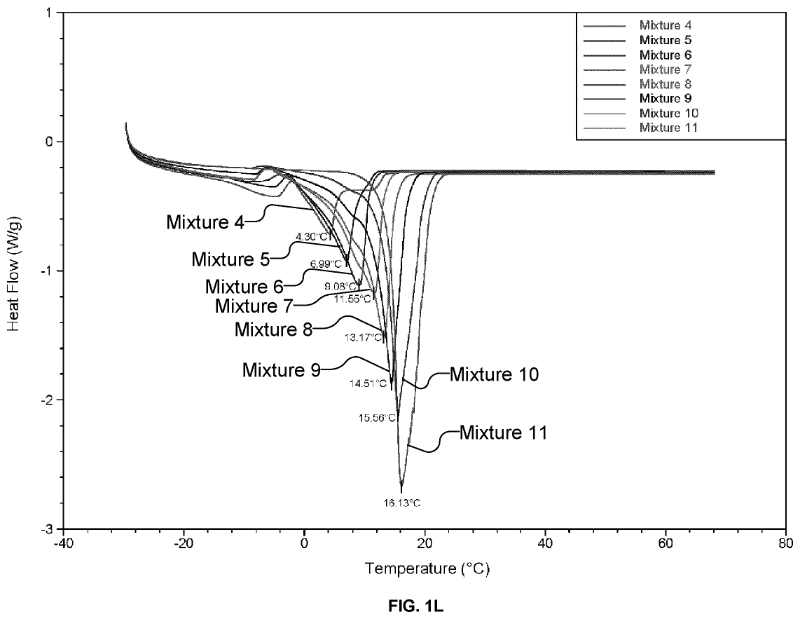

The constituents of neem oil have various melting points and, as a natural product, the constituent ratios and thus melting point of neem oil varies from sample to sample. The melting point of natural oils may also be affected by impurities such as plant tissue and other substances; for example, the cold-pressed neem oil tested here comprised approximately 5% impurities by weight. Neem oil generally has a melting point in the vicinity of 14-18° C., although this does not always appear as a sharp peak in a DSC measurement due to the aforementioned impurities and various melting points of the constituents of neem oil (as illustrated in FIG. 1A). Observationally, the tested neem oil is believed to have a melting point within the typical range, although the DSC measurements were not themselves conclusive (as described in greater detail below.) Substantially pure octanoic acid was observed to have a melting point of 16.13° C. Mixture ratios of at least between about 80:20 and 10:90 provided reduced melting points for both the oil and aliphatic acid. Mixture ratios of between about 80:20 and 60:40 tended to have melting points lower than the melting points of the oil and the aliphatic acid and thus were eutectic. For instance, the plateau of the 80:20 mixture and the considerable melting point reduction of the 70:30 mixture indicate that mixture ratios of between about 80:20 and 70:30 will tend to provide melting points well below the ingredients' melting points of 9° C. and 16.13° C., respectively, and thus are generally eutectic as that term is used herein. Other mixture ratio ranges (e.g. 70:30 to 60:40) are also eutectic, as shown in Table 1. An apparent minimum melting point was observed in the vicinity of a 70:30 mixture ratio (e.g. in a range of between about 80:20 and 60:40, and/or in a range of between about 75:25 and 65:35).

DSC heat flow diagrams are shown for each mixture as one of the charts of FIGS. 1A-1K. A heat flow diagram depicting the results of the DSC measurement for mixture 1 (i.e. 100% neem oil) is shown in FIG. 1A, which shows a plateau rather than a sharp peak at a specific melting point. This is consistent with neem oil's natural composition, so a melting point in the usual range of 14-18° C. may be assumed. Heat flow diagrams depicting the results of the DSC measurement for mixtures 2 and 3 are shown in FIGS. 1B and 1C, respectively, which show similar plateaus for mixture ratios of about 90:10 to about 80:20; FIGS. 1A-1C collectively show heat flow which does not reach a threshold of device sensitivity and so can generally be considered to show behavior in the plateau range without necessarily indicating a single sharp melting point. A heat flow diagram depicting the results of the DSC measurement for mixture 4 is shown in FIG. 1D, which shows a melting point for the mixture of about 4.3° C. —well below the ingredients' individual melting points and indicating that mixtures between about 80:20 and 70:30 will generally tend to be eutectic. A heat flow diagram depicting the results of the DSC measurement for mixture 5 is shown in FIG. 1E, which shows a melting point for the mixture of about 6.99° C. —well below the ingredients' individual melting points. A heat flow diagram depicting the results of the DSC measurement for mixture 6 is shown in FIG. 1F, which shows a melting point for the mixture of about 9.08° C. —approximately in line with neem oil's melting point and well below octanoic acid's melting point, indicating the mixtures between about 60:40 and 50:50 will generally tend to be eutectic. Combining the foregoing results, the results indicate that mixture ratios between about 80:20 and 50:50 will generally tend to be eutectic.

Further heat flow diagrams for mixtures 7-11 are shown in FIGS. 1G-1K. A heat flow diagram depicting the results of the DSC measurement for mixture 7 is shown in FIG. 1G, which shows a melting point for the mixture of about 11.5° C. —above the melting point of neem oil and below the melting point of octanoic acid. A heat flow diagram depicting the results of the DSC measurement for mixture 8 is shown in FIG. 1H, which shows a melting point for the mixture of about 13.17° C. —above the melting point of neem oil and below the melting point of octanoic acid. A heat flow diagram depicting the results of the DSC measurement for mixture 9 is shown in FIG. 1I, which shows a melting point for the mixture of about 14.51° C. —above the melting point of neem oil and below the melting point of octanoic acid. A heat flow diagram depicting the results of the DSC measurement for mixture 10 is shown in FIG. 1J, which shows a melting point for the mixture of about 15.56° C. —above the melting point of neem oil and below the melting point of octanoic acid. A heat flow diagram depicting the results of the DSC measurement for mixture 11 is shown in FIG. 1K, which shows a melting point for substantially pure octanoic acid of about 16.13° C. —above the melting point of neem oil and below the melting point of octanoic acid. A composite heat flow diagram depicting the results of FIGS. 1D-1K is shown in FIG. 1L for convenience.

### Example 2—Palm Oil and Octanoic Acid

Eleven exemplary pesticidal compositions, each comprising a different mixture ratio of palm oil and octanoic acid, were prepared according to the following description. Each composition comprised a combined 10-20 mg of palm oil and octanoic acid. The palm oil and octanoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of palm oil and 4 mg of octanoic acid. The mixture's melting point was then measured by differential scanning calorimeter. The compositions of the resulting pesticidal composition are therefore as shown below in Table 2:

TABLE 2
Pesticidal Compositions of Example 2

| | Palm oil:octanoic acid | |
|---|---|---|
| Mixture | mixture ratio | Melting Point |
| 1 | 100% palm oil | Plateau of about 30° C. |
| 2 | 90:10 | Plateau of about 20° C. |
| 3 | 80:20 | −4.39° C. and 2.97° C. |
| 4 | 70:30 | 4.88° C. |
| 5 | 60:40 | 3.73° C., 3.92° C., and |
| | | 9.63° C. |
| 6 | 50:50 | 11.5° C. |
| 7 | 40:60 | 12.8° C. |
| 8 | 30:70 | 13.8° C. |
| 9 | 20:80 | 14.4° C. |
| 10 | 10:90 | 15.4° C. |
| 11 | 100% octanoic acid | 17.2° C. |

The constituents of palm oil have various melting points, similar to neem oil. DSC measurements registered a plateau for the tested 100% palm oil composition starting in the vicinity of about 30° C. Substantially pure octanoic acid was observed to have a melting point of about 17.2° C. Mixture ratios of between about 90:10 and 10:90 provided reduced melting points for both the oil and aliphatic acid. Mixture ratios of between about 90:10 and 10:90 tended to have melting points lower than the melting points of the oil and the aliphatic acid and thus were eutectic. Mixture ratios of between about 90:10 and 60:40 provided particularly strong reductions in the mixture's melting point relative to its ingredients' melting points. (Note that, although a plateau of 20° C. is shown for the 90:10 mixture, at that plateau a substantial proportion of the palm oil's constituents were melted even below octanoic acid's melting point of 17.2° C. Furthermore, the 80:20 mixture has a melting point well below the melting points of the ingredients, indicating that mixtures between about 90:10 and 80:20 will thus tend to melt below 17.2° C. and are therefore eutectic.) An apparent minimum melting point was observed in the vicinity of an 80:20 mixture ratio (e.g. in a range of between about 90:10 and 70:30, and/or in a range of between about 85:15 and 75:25).

### Example 3—Coconut Oil and Octanoic Acid

Eleven exemplary pesticidal compositions, each comprising a different mixture ratio of coconut oil and octanoic acid, were prepared according to the following description. Each composition comprised a combined 10-20 mg of coconut oil and octanoic acid. The coconut oil and octanoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of coconut oil and 4 mg of octanoic acid. The mixture's melting point was then measured by differential scanning calorimeter. The compositions of the resulting pesticidal composition are therefore as shown below in Table 3:

TABLE 3
Pesticidal Compositions of Example 3

| | Coconut oil:octanoic acid | | |
|---|---|---|---|
| Mixture | mixture ratio | Melting Point | |
| 1 | 100% coconut oil | 23.93° | C. |
| 2 | 90:10 | 5.74° C. and 21.65° C. | |
| 3 | 80:20 | 7.72° C. and 19.16° C. | |
| 4 | 70:30 | 8.78° C. and 16.99° C. | |
| 5 | 60:40 | 10.1° | C. |
| 6 | 50:50 | 11.1° | C. |
| 7 | 40:60 | 11.8° | C. |
| 8 | 30:70 | 13.3° | C. |
| 9 | 20:80 | 14.4° | C. |
| 10 | 10:90 | 15.72° | C. |
| 11 | 100% octanoic acid | 16.62° | C. |

Substantially pure coconut oil was observed to have a melting point of about 23.93° C. and substantially pure octanoic acid was observed to have a melting point of about 16.62° C. Mixture ratios of between about 90:10 and 10:90 provided reduced melting points for both the oil and aliphatic acid. Mixture ratios of between about 90:10 and 10:90 tended to have melting points lower than the melting points of at least some constituents of the oil and the aliphatic acid and thus were eutectic. Mixture ratios of between about 90:10 and 50:50 provided particularly strong reductions in coconut oil's melting point and may be preferred in embodiments where low melting temperatures and high concentrations of coconut oil are desired. As another example, mixture ratios of between about 70:30 and 10:90 tend to have melting points less than the melting points of substantially all of the constituents of the oil and the aliphatic acid; such mixtures are also eutectic and may be preferred in some embodiments. An apparent minimum melting point was observed in the vicinity of a 60:40 mixture ratio (e.g. in a range of between about 70:30 and 50:50, and/or in a range of between about 65:35 and 55:45).

### Example 4—Karanja Oil and Octanoic Acid

Eleven exemplary pesticidal compositions, each comprising a different mixture ratio of karanja oil and octanoic acid, were prepared according to the following description. Each composition comprised a combined 10-20 mg of karanja oil and octanoic acid. The karanja oil and octanoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of karanja oil and 4 mg of octanoic acid. The mixture's melting point was then measured by differential scanning calorimeter. The compositions of the resulting pesticidal composition are therefore as shown below in Table 4:

TABLE 4
Pesticidal Compositions of Example 4

| | Karanja oil:octanoic acid | | |
|---|---|---|---|
| Mixture | mixture ratio | Melting Point | |
| 1 | 100% karanja oil | 6.93° | C. |
| 2 | 90:10 | 4.09° | C. |
| 3 | 80:20 | 0.78° | C. |
| 4 | 70:30 | −1.48° C., 3.02° C. and | |
| | | 10.3° C. | |
| 5 | 60:40 | 6.1° | C. |
| 6 | 50:50 | 8.72° | C. |
| 7 | 40:60 | 11.32° | C. |
| 8 | 30:70 | 13.27° | C. |
| 9 | 20:80 | 14.36° | C. |
| 10 | 10:90 | 15.52° | C. |
| 11 | 100% octanoic acid | 16.8° | C. |

Substantially pure karanja oil was observed to have a melting point of about 6.93° C. and substantially pure octanoic acid was observed to have a melting point of about 16.8° C. Mixture ratios of between about 90:10 and 10:90 provided reduced melting points for both the oil and aliphatic acid. Mixture ratios of between about 90:10 and 60:40 tended to have melting points lower than the melting points of the oil and the aliphatic acid and thus were eutectic. An apparent minimum melting point was observed in the vicinity of an 80:20 mixture ratio (e.g. in a range of between about 90:10 and 70:30, and/or in a range of between about 85:15 and 75:25).

### Example 5—Neem Oil and Oleic Acid

Eleven exemplary pesticidal compositions, each comprising a different mixture ratio of neem oil and oleic acid, were prepared according to the following description. Each composition comprised a combined 10-20 mg of cold-pressed neem oil and oleic acid. The neem oil and oleic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of neem oil and 4 mg of oleic acid. The mixture's melting point was then measured by differential scanning calorimeter. The compositions of the resulting pesticidal composition are therefore as shown below in Table 5:

TABLE 5
Pesticidal Compositions of Example 5

| | Neem oil:oleic acid | | |
|---|---|---|---|
| Mixture | mixture ratio | Melting Point | |
| 1 | 100% neem oil | Plateau range | |
| 2 | 90:10 | 5.6° | C. |
| 3 | 80:20 | 3.76° | C. |
| 4 | 70:30 | 2.04° | C. |
| 5 | 60:40 | 0.48° C. and 4.7° C. | |
| 6 | 50:50 | 0.91° C. and 6.2° C. | |
| 7 | 40:60 | 1.39° C. and 7.54° C. | |
| 8 | 30:70 | 8.79° | C. |
| 9 | 20:80 | 9.8° | C. |
| 10 | 10:90 | 10.77° | C. |
| 11 | 100% oleic acid | 11.31° | C. |

As noted above, cold-pressed neem oil may have impurities and neem oil in general has varying ratios of constituents which may themselves have having various melting points. The composition of 100% neem oil tested here yielded a plateau when measured by DSC. Observationally, it appeared to have a melting point in the typical range of 14-18° C. Substantially pure oleic acid was observed to have a melting point of about 11.31° C. Mixture ratios of between about 90:10 and 10:90 provided reduced melting points for both the oil and aliphatic acid. Mixture ratios of between about 90:10 and 40:60 tended to have melting points lower than the melting points of the oil and the aliphatic acid and thus were eutectic. An apparent minimum melting point was observed in the vicinity of a 70:30 mixture ratio (e.g. in a range of between about 80:20 and 60:40, and/or in a range of between about 75:25 and 65:35). In some embodiments, such as where the solidification activity of only a portion of the constituents of neem oil is of concern, mixture ratios in the vicinity of 60:40 may be preferred (e.g. in a range of between about 70:30 and 40:60, and/or in a range of between about 65:35 and 55:45), as these achieve apparent minimum melting points for at least some constituents of neem oil.

### Example 6—Neem Oil and Trans-3 Hexenoic Acid

Eleven exemplary pesticidal compositions, each comprising a different mixture ratio of neem oil and trans-3 hexenoic acid, were prepared according to the following description. Each composition comprised a combined 10-20 mg of cold-pressed neem oil and trans-3 hexenoic acid. The neem oil and trans-3 hexenoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of neem oil and 4 mg of trans-3 hexenoic acid. The mixture's melting point was then measured by differential scanning calorimeter. The compositions of the resulting pesticidal composition are therefore as shown below in Table 6:

TABLE 6
Pesticidal Compositions of Example 6

| | Neem oil:trans-3 hexenoic | | |
|---|---|---|---|
| Mixture | acid mixture ratio | Melting Point | |
| 1 | 100% neem oil | Plateau range | |
| 2 | 90:10 | 4.02° | C. |
| 3 | 80:20 | 1.61° | C. |
| 4 | 70:30 | −1.46° C. and 7.18° C. | |
| 5 | 60:40 | 4.95° | C. |
| 6 | 50:50 | 3.25° C. (plateau) and 8.04° C. | |
| 7 | 40:60 | 7.85° | C. |
| 8 | 30:70 | 8.89° | C. |
| 9 | 20:80 | 9.98° | C. |
| 10 | 10:90 | 11.57° | C. |
| 11 | 100% trans-3 hexenoic acid | 11.36° | C. |

As noted above, cold-pressed neem oil may have impurities and neem oil in general has varying ratios of constituents which may themselves have having various melting points. The composition of 100% neem oil tested here yielded a plateau when measured by DSC. Observationally, it appeared to have a melting point in the typical range of 14-18° C. Substantially pure trans-3 hexenoic acid was observed to have a melting point of about 11.36° C. Mixture ratios of between about 90:10 and 10:90 provided reduced melting points for both the oil and aliphatic acid. Mixture ratios of between about 90:10 and 50:50 tended to have melting points lower than the melting points of the oil and the aliphatic acid and thus were eutectic. An apparent minimum melting point was observed in the vicinity of a 80:20 mixture ratio (e.g. in a range of between about 90:10 and 70:30, and/or in a range of between about 85:15 and 75:25). In some embodiments, such as where the solidification activity of only a portion of the constituents of neem oil is of concern, mixture ratios in the vicinity of 70:30 may be preferred (e.g. in a range of between about 80:20 and 60:40, and/or in a range of between about 75:25 and 65:35), as these achieve apparent minimum melting points for at least some constituents of neem oil.

### Example 7—Neem Oil and Decanoic Acid

Eleven exemplary pesticidal compositions, each comprising a different mixture ratio of neem oil and decanoic acid, were prepared according to the following description. Each composition comprised a combined 10-20 mg of cold-pressed neem oil and decanoic acid. The neem oil and decanoic acid were passively mixed by commingling in liquid phase in the testing vessel (an aluminum pan with an aluminum cap) at a temperature above each ingredient's melting point. Mixture ratios were determined by weight—e.g. a 10 mg mixture in 60:40 ratio would comprise 6 mg of neem oil and 4 mg of decanoic acid. The mixture's melting point was then measured by differential scanning calorimeter. The compositions of the resulting pesticidal composition are therefore as shown below in Table 7:

TABLE 7
Pesticidal Compositions of Example 7

| | Neem oil:decanoic acid | | |
|---|---|---|---|
| Mixture | mixture ratio | Melting Point | |
| 1 | 100% neem oil | Plateau range | |
| 2 | 90:10 | 4.44° C. and 8.77° C. plateau | |
| 3 | 80:20 | 2.13° C. and 11.53° C. | |
| 4 | 70:30 | 18.37° C. plateau | |
| 5 | 60:40 | 22.29° | C. |
| 6 | 50:50 | 24.91° | C. |
| 7 | 40:60 | 27.08° | C. |
| 8 | 30:70 | 28.68° | C. |
| 9 | 20:80 | 30° | C. |
| 10 | 10:90 | 31° | C. |
| 11 | 100% decanoic acid | 32° | C. |

As noted above, cold-pressed neem oil may have impurities and neem oil in general has varying ratios of constituents which may themselves have having various melting points. The composition of 100% neem oil tested here yielded a plateau when measured by DSC. Observationally, it appeared to have a melting point in the typical range of 14-18° C. Substantially pure decanoic acid was observed to have a melting point of about 11.36° C. Mixture ratios of between about 90:10 and 10:90 provided reduced melting points for both the oil and aliphatic acid. Mixture ratios of between about 90:10 and 80:20 tended to have melting points lower than the melting points of at least some constituents of the oil and the aliphatic acid and thus were eutectic. An apparent minimum melting point for at least some constituents of neem oil was observed in the vicinity of an 80:20 mixture ratio (e.g. in a range of between about 90:10 and 70:30, and/or in a range of between about 85:15 and 75:25).

### Concluding Generalities

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A pesticidal composition comprising:
an oil having an oil melting point;
an aliphatic acid having an acid melting point, the aliphatic acid and oil forming a mixture having a mixture melting point below the oil melting point and the acid melting point, wherein at least one of:
the aliphatic acid is effective to reduce the mixture melting point to below the oil melting point, and
the oil is effective to reduce the melting point of the mixture to below the acid melting point.

2. The composition according to claim 1 wherein a weight ratio of the oil to the aliphatic acid is between about 90:10 and 10:90, optionally wherein the weight ratio of the oil to the aliphatic acid is between about at least one of: 90:10 and 20:80; 90:10 and 30:70; 90:10 and 40:60; 90:10 and 50:50; 90:10 and 60:40; 90:10 and 70:30; 90:10 and 80:20; 80:20 and 10:90; 80:20 and 20:80; 80:20 and 30:70; 80:20 and 40:60; 80:20 and 50:50; 80:20 and 60:40; 80:20 and 70:30; 70:30 and 10:90; 70:30 and 20:80; 70:30 and 30:70; 70:30 and 40:60; 70:30 and 50:50; 70:30 and 60:40; 60:40 and 10:90; 60:40 and 20:80; 60:40 and 30:70; 60:40 and 40:60; 60:40 and 50:50; 50:50 and 10:90; 50:50 and 20:80; 50:50 and 30:70; and 50:50 and 40:60.

3. (canceled)

4. The composition according to claim 1 wherein the composition comprises a pesticidal active ingredient comprising at least one of the oil and the aliphatic acid.

5. The composition according to claim 1 wherein:
the aliphatic acid comprises a saturated or unsaturated fatty acid, optionally wherein the fatty acid has a carbon chain length no greater than 12;
the fatty acid comprises at least one of: a trans-unsaturated C—C bond, a cis-unsaturated C—C bond, and a plurality of conjugated unsaturated C—C bonds;
the fatty acid comprises at least one of: a trans-2, trans-3, trans-4, trans-5, trans-6, trans-7, trans-8, trans-9, trans-10, trans-11, cis-2, cis-3, cis-4, cis-5, cis-6, cis-7, cis-8, and cis-9, cis-10, and cis-11 unsaturated bond; or
the fatty acid comprises at least one of a trans-hexenoic acid, a cis-hexenoic acid, a hexa-dienoic acid, a hexynoic acid, a trans-heptenoic acid, a cis-heptenoic acid, a hepta-dienoic acid, a heptynoic acid, a trans-octenoic acid, a cis-octenoic acid, an octa-dienoic acid, an octynoic acid, a trans-nonenoic acid, a cis-nonenoic acid, a nona-dienoic acid, a nonynoic acid, a trans-decenoic acid, a cis-decenoic acid, a deca-dienoic acid, a decynoic acid, a trans-dodecenoic acid, a cis-dodecenoic acid, a dodeca-dienoic acid, a dodecynoic acid, hexanoic acid, heptanoic acid, octanoic acid, nonanoic acid, decanoic acid, and dodecanoic acid.

6. (canceled)

7. (canceled)

8. (canceled)

9. (canceled)

10. The composition according to claim 5 wherein the fatty acid is selected from the group consisting of: trans-3 hexenoic acid, octanoic acid, decanoic acid, and oleic acid.

11. The composition according to claim 1 wherein the oil comprises a fatty acid ester.

12. The composition according to claim 11 wherein the fatty acid ester comprises a wax ester, optionally wherein the wax ester comprises an extract, constituent, and/or derivative of a natural pesticidal oil selected from the group consisting of: neem oil, karanja oil, clove oil, clove leaf oil, peppermint oil, spearmint oil, mint oil, cinnamon oil, thyme oil, oregano oil, rosemary oil, geranium oil, lime oil, lavender oil, anise oil, lemongrass oil, tea tree oil, apricot kernel oil, bergamot oil, carrot seed oil, cedar leaf oil, citronella oil, clove bud oil, coriander oil, coconut oil, eucalyptus oil, evening primrose oil, fennel oil, ginger oil, grapefruit oil, nootkatone(+), grapeseed oil, lavender oil, marjoram oil, pine oil, scotch pine oil, garlic oil, and/or safflower oil, and combinations thereof.

13. (canceled)

14. The composition according to claim 1 wherein the mixture melting point is between about −5° C. and at least one of: 0° C., 5° C., 10° C., 15° C., 20° C., 25° C., and 30° C.

15. The composition according to claim 1 wherein the oil comprises at least one of palm oil, coconut oil, and karanja oil; the aliphatic acid comprises octanoic acid, and the weight ratio of the oil to the octanoic acid is between about at least one of: 90:10 and 60:40, 90:10 and 70:30, 90:10 and 80:20, 80:20 and 60:40, 80:20 and 70:30, 70:30 and 60:40, 85:15 and 75:25, and 65:35 and 55:45.

16. The composition according to claim 1 wherein the oil comprises neem oil; the aliphatic acid comprises oleic acid, and the weight ratio of the neem oil to the oleic acid is between about at least one of: 80:20 and 40:60, 80:20 and 50:50, 80:20 and 60:40, 80:20 and 70:30, 70:30 and 40:60, 70:30 and 50:50, 70:30 and 60:40, 60:40 and 40:60, 60:40 and 50:50, and 50:50 and 40:60.

17. The composition according to claim 1 wherein the oil comprises neem oil; the aliphatic acid comprises trans-3 hexenoic acid, and the weight ratio of the neem oil to the trans-3 hexenoic acid is between about at least one of: 90:10 and 40:60, 90:10 and 50:50, 90:10 and 60:40, 90:10 and 70:30, 90:10 and 80:20, 80:20 and 40:60, 80:20 and 50:50, 80:20 and 60:40, 80:20 and 70:30, 70:30 and 40:60, 70:30 and 50:50, 70:30 and 60:40, 60:40 and 40:60, 60:40 and 50:50, and 50:50 and 40:60.

18. The composition according to claim 1 wherein the oil comprises neem oil; the aliphatic acid comprises decanoic acid, and the weight ratio of the neem oil to the decanoic acid is between about at least one of: 90:10 and 80:20, and 85:15 and 75:25.

19. The composition according to claim 1 wherein the oil comprises neem oil; the aliphatic acid comprises octanoic acid, and the weight ratio of the neem oil to the octanoic acid is between about at least one of: 80:20 and 60:40, 80:20 and 70:30, 70:30 and 60:40, and 75:25 and 65:35.

20. The composition according to claim 1 wherein the mixture comprises a eutectic mixture of the aliphatic acid and the oil having a eutectic point below the oil melting point and the acid melting point, the aliphatic acid is effective to reduce the mixture melting point to below the oil melting point, and the oil is effective to reduce the melting point of the mixture to below the acid melting point.

21. The composition according to claim 1, wherein at least one of the mixture melting point, oil melting point and aliphatic acid melting point comprises a viscosity transition point, optionally wherein the viscosity transition point comprises a pour point.

22. (canceled)

23. A method for making a pesticidal composition comprising mixing an oil having an oil melting point with an aliphatic acid having an acid melting point, thereby forming a mixture having a mixture melting point below the oil melting point and the acid melting point, wherein at least one of:
the aliphatic acid is effective to reduce the mixture melting point to below the oil melting point, and
the oil is effective to reduce the melting point of the mixture to below the acid melting point.

24. A method of enhancing the properties of a pesticidal composition comprising an oil, the method comprising mixing an aliphatic acid with the oil, the aliphatic acid effective to reduce a melting point of at least the oil in the pesticidal composition; or a method of enhancing the properties of a pesticide comprising an aliphatic acid, the method comprising mixing an oil with the aliphatic acid, the oil effective to reduce a melting point of at least the aliphatic acid in the pesticidal composition.

25. (canceled)

26. (canceled)

27. (canceled)

28. The method according to claim 23 comprising heating the oil to a temperature greater than the oil melting point prior to mixing and, after the mixing, cooling the oil to below the oil melting point in liquid phase; or the method comprising heating the aliphatic acid to a temperature greater than the acid melting point prior to mixing and, after the mixing, cooling the aliphatic acid to below the acid melting point in liquid phase; the method optionally further comprising applying the pesticidal composition to at least one plant, the locus thereof, or propagation material thereof, which is susceptible to or infested with the at least one plant pest.

29. (canceled)

30. (canceled)

31. (canceled)

32. The method according to claim 23, wherein at least one of the mixture melting point, oil melting point and aliphatic acid melting point comprises a viscosity transition point, optionally wherein the viscosity transition point comprises a pour point.

33. (canceled)

34. A method of applying at least one pesticidal composition to control at least one plant pest comprising:
providing the pesticidal composition of claim 1;
applying the pesticidal composition to at least one plant, the locus thereof, or propagation material thereof, which is susceptible to or infested with the at least one plant pest,
optionally wherein the at least one plant comprises a tree and the at least one plant pest comprises a pest of a tree, where applying the pesticidal composition comprises applying pesticidal composition as a dormant oil to the tree.

35. (canceled)
